(19) United States
(12) Patent Application Publication
(10) Pub. No.: US 2022/0108825 A1
(43) Pub. Date: Apr. 7, 2022

(54) Coil Device and Power Conversion Device

(71) Applicant: Mitsubishi Electric Corporation, Chiyoda-ku, Tokyo (JP)

(72) Inventors: Kazuya YAMAMOTO, Chiyoda-ku, TOKYO (JP); Kenta FUJII, Chiyoda-ku, Tokyo (JP); Tomohito FUKUDA, Chiyoda-ku, Tokyo (JP); Takashi KUMAGAI, Chiyoda-ku, Tokyo (JP)

(73) Assignee: Mitsubishi Electric Corporation, Chiyoda-ku, Tokyo (JP)

(21) Appl. No.: 17/425,763

(22) PCT Filed: Mar. 4, 2020
(86) PCT No.: PCT/JP2020/009253

§ 371 Date: Jul. 26, 2021

(30) Foreign Application Priority Data
Mar. 19, 2019 (JP) 2019-050788

(51) Int. Cl. H01F 27/06; H01F 27/24; H01F 27/28

(52) U.S. Cl. CPC H01F 27/06; H01F 27/28; H01F 27/24

(57) ABSTRACT

A coil device includes: a core having a first surface and a second surface located opposite to the first surface; a coil member including a first portion and a second portion that are spaced apart from each other in a first direction along the first surface; and a support portion in contact with the first surface and the second surface to support the core. The core includes a middle leg sandwiched between the first portion and the second portion in the first direction. The core is provided with a first slit as a first recessed portion recessed relative to the first surface and reaching the middle leg. The support portion includes a first protruding portion disposed inside the first slit and in contact with the middle leg.

### TECHNICAL FIELD

The present invention relates to a coil device and a power conversion device.

### BACKGROUND ART

For example, a power conversion device such as a DC/DC conversion device is equipped with coil devices such as a smoothing coil and a transformer. When the power conversion device operates, the coil devices generate heat. As the temperature rises in each coil device, power loss increases, and thus, each coil device needs to have a heat dissipation structure.

Japanese Patent Laying-Open No. 2015 -70081 discloses a coil device in which only a part of a core pressing member is in contact with an upper surface of a core, and a gap is provided between another part of the core pressing member and the core.

### CITATION LIST

### Patent Literature

PTL 1: Japanese Patent Laying-Open No. 2015-70081

### SUMMARY OF INVENTION

### Technical Problem

In recent years, a wide bandgap semiconductor such as SiC and GaN has been applied to a switching element mounted on a power conversion device. Such a switching element can operate at a high temperature of 200° C. or higher, for example. Accordingly, the coil device mounted on the power conversion device has also been demanded to be further improved in heat dissipation performance in order to accommodate such a high temperature operation.

A main object of the present invention is to provide: a coil device including a core enhanced in heat dissipation performance as compared with conventional coil devices; and a power conversion device.

### Solution to Problem

A coil device according to the present invention includes: a core having a first surface and a second surface located opposite to the first surface; a coil including a first portion and a second portion that are spaced apart from each other in a first direction along the first surface; and a support portion in contact with at least a part of each of the first surface and the second surface to support the core. The core includes a middle leg sandwiched between the first portion and the second portion in the first direction. The core is provided with a first recessed portion recessed relative to the first surface and reaching the middle leg. The support portion includes a first protruding portion disposed inside the first recessed portion and in contact with the middle leg.

A power conversion device according to the present invention includes: a main conversion circuit to convert received electric power and output converted electric power; and a control circuit to output a control signal for controlling the main conversion circuit to the main conversion circuit. The main conversion circuit includes the coil device.

### ADVANTAGEOUS EFFECTS OF INVENTION

The present invention can provide: a coil device that is contrastive to conventional coil devices; and a power conversion device.

### BRIEF DESCRIPTION OF DRAWINGS

FIG. 1 is a circuit diagram of a power conversion device according to a first embodiment.

FIG. 2 is a perspective view of the coil device according to the first embodiment.

FIG. 3 is an exploded perspective view of the coil device according to the first embodiment.

FIG. 4 is a cross-sectional view taken along an arrow IV-IV in FIG. 3.

FIG. 5 is a plan view of the circuit device according to the first embodiment.

FIG. 6 is a cross-sectional view of a coil device according to a second embodiment.

FIG. 7 is a cross-sectional view of a coil device according to a third embodiment.

FIG. 8 is a cross-sectional view of a coil device according to a fourth embodiment.

FIG. 9 is a cross-sectional view of a coil device according to a fifth embodiment.

FIG. 10 is a cross-sectional view of a coil device according to a sixth embodiment.

FIG. 11 is a perspective view of a core shown in FIG. 10.

FIG. 12 is a perspective view showing a modification of a core of the coil device according to the sixth embodiment.

### DESCRIPTION OF EMBODIMENTS

In the following, embodiments of the present invention will be described with reference to the accompanying drawings, in which the same or corresponding components are denoted by the same reference characters, and the description thereof will not be repeated. For convenience of description, an X direction as the third direction, a Y direction as the first direction, and a Z direction as the second direction are introduced.

### First Embodiment

### Configuration of Power Conversion Device

FIG. 1 is a circuit diagram showing an example of a circuit configuration of a power conversion device 200 according to the first embodiment. As shown in the figure, power conversion device 200 is a DC-DC converter, for example. Power conversion device 200 includes a main conversion circuit and a control circuit 5. The main conversion circuit receives a direct-current (DC) voltage Vin through an input terminal 110, converts the received DC voltage Vin into a DC voltage Vout, and then outputs DC voltage Vout from an output terminal 111. The main conversion circuit includes an inverter circuit 1 connected to input terminal 110, a transformer circuit 2, a rectifier circuit 3, and a smoothing circuit 4 connected to output terminal 111. Control circuit 5 outputs a control signal for controlling the main conversion circuit to the main conversion circuit.

As shown in FIG. 1, inverter circuit 1 includes switching elements 6A, 6B, 6C, and 6D. Each of switching elements 6A, 6B, 6C, and 6D is a metal oxide semiconductor field effect transistor (MOSFET) or an insulated gate bipolar transistor (IGBT), for example. Each of switching elements 6A, 6B, 6C, and 6D is formed of a semiconductor material such as silicon (Si), silicon carbide (SiC), or gallium nitride (GaN). Control circuit 5 is provided to output control signals to switching elements 6A, 6B, 6C, and 6D.

Transformer circuit 2 includes a transformer 121. Transformer 121 includes: a primary-side coil conductor connected to inverter circuit 1; and a secondary-side coil conductor magnetically coupled to the primary-side coil conductor and connected to rectifier circuit 3. The primary-side coil conductor is a high-voltage side coil conductor, for example. The secondary-side coil conductor is a low-voltage side coil conductor, for example. A resonance coil 122 is connected between inverter circuit 1 and the primary-side coil conductor.

Rectifier circuit 3 includes diodes 6E, 6F, 6G, and 6H. Each of diodes 6E, 6F, 6G, and 6H is formed of a semiconductor material such as Si, SiC, or GaN.

Smoothing circuit 4 includes: a coil device 100 forming a smoothing coil; and a capacitor 7.

Power conversion device 200 further includes a filter coil 123, for example, between inverter circuit 1 and input terminal 110. Power conversion device 200 further includes a capacitor 8, for example, connected in parallel with inverter circuit 1 to input terminal 110.

Power conversion device 200 receives a DC voltage Vin of 100V or more and 600V or less, for example. Power conversion device 200 outputs a DC voltage Vout of 12V or more and 48V or less, for example. Specifically, DC voltage Vin input into input terminal 110 is converted by inverter circuit 1 into a first AC voltage. The first AC voltage is converted by transformer circuit 2 into a second AC voltage lower than the first AC voltage. The second AC voltage is rectified by rectifier circuit 3. Smoothing circuit 4 smooths the voltage output from rectifier circuit 3. Through output terminal 111, power conversion device 200 outputs DC voltage Vout that is output from smoothing circuit 4.

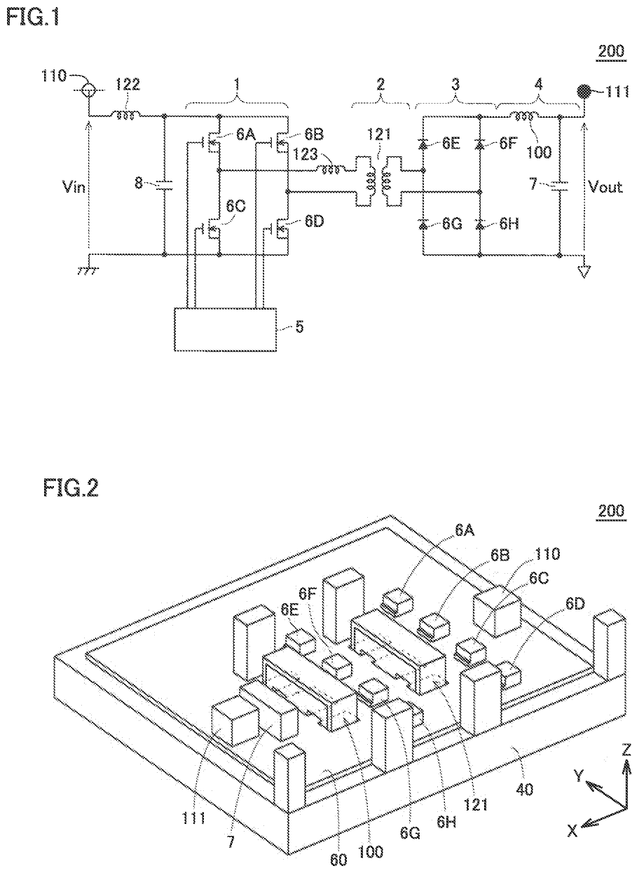

FIG. 2 is a perspective view of power conversion device 200. FIG. 2 shows only a part of power conversion device 200 but does not show, for example, control circuit 5 and the like. As shown in FIG. 2, in power conversion device 200, coil device 100 is mounted, for example, on a printed board 60. Coil device 100 includes: a coil member 20 formed, for example, as a wiring pattern of printed board 60; and a core 10 penetrating through printed board 60. Printed board 60 is supported by a first support portion 40. First support portion 40 forms a part of a housing of power conversion device 200, for example. The material forming first support portion 40 includes metal. The ground potential of power conversion device 200 is connected to first support portion 40. First support portion 40 includes, for example, a first support portion disposed so as to face printed board 60 in second direction Z and supporting core 10, and a second support portion protruding toward printed board 60 relative to the first support portion and supporting the outer edge portion of printed board 60.

Also, at least one of transformer 121, resonance coil 122, filter coil 123, input terminal 110, output terminal 111, switching elements 6A, 6B, 6C, and 6D, diodes 6E, 6F, 6G, and 6H, and capacitors 7 and 8 may be further mounted on printed board 60.

### Configuration of Coil Device

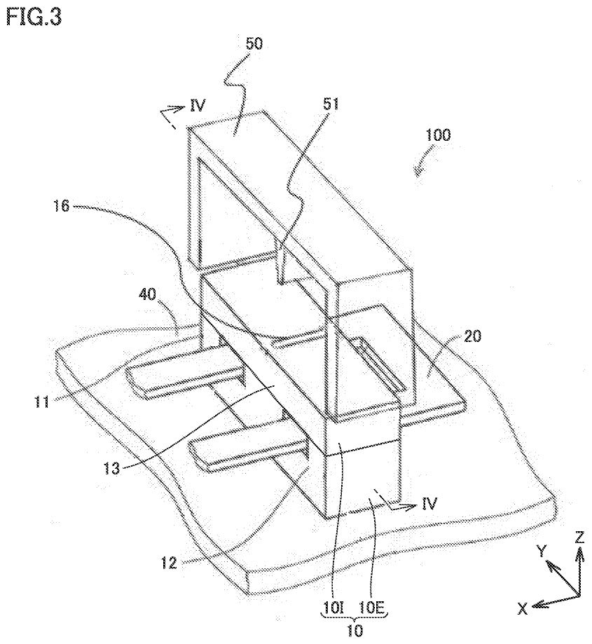

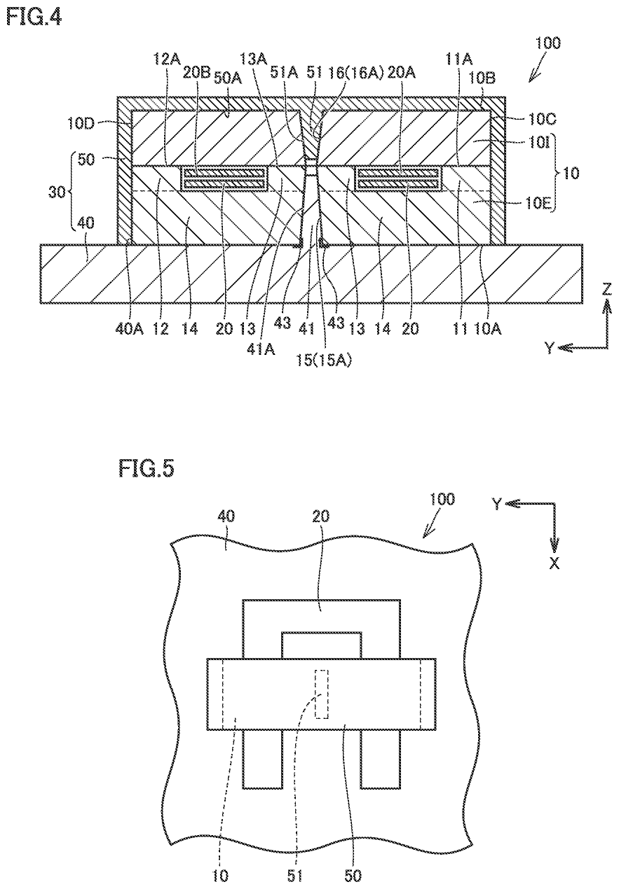

FIG. 3 is an exploded perspective view of coil device 100. FIG. 4 is a cross-sectional view taken along an arrow IV-IV in FIG. 3. FIG. 5 is a plan view of coil device 100. As shown in FIGS. 2 to 5, coil device 100 according to the first embodiment includes core 10, coil member 20, a support portion 30 (a first support portion 40 and a second support portion 50), and printed board 60. FIGS. 3 to 5 each do not show printed board 60.

The material forming core 10 includes a magnetic material. Core 10 is a ferrite core made of manganese-zinc (Mn—Zn) ferrite, nickel-zinc (Ni—Zn) ferrite or the like, an amorphous core, or an iron dust core, for example.

Core 10 has a first surface 10A and a second surface 10B that is located opposite to first surface 10A. First surface 10A and second surface 10B extend in first direction Y and third direction X. At least a part of each of first surface 10A and second surface 10B is in contact with support portion 30. At least a part of first surface 10A is in contact with first support portion 40. At least a part of second surface 10B is in contact with second support portion 50. Preferably, first surface 10A and second surface 10B are entirely in contact with support portion 30.

Core 10 further has a third surface 10C and a fourth surface 10D that is located opposite to third surface 10C. Third surface 10C and fourth surface 10D extend in second direction Z and third direction X. At least a part of each of third surface 10C and fourth surface 10D is in contact with support portion 30. Preferably, third surface 10C and fourth surface 10D are entirely in contact with support portion 30.

Core 10 includes a first core portion 101 and a second core portion 10E, for example. First core portion 101 and second core portion 10E are stacked in second direction Z. First core portion 101 has second surface 10B and one portion of each of third surface 10C and fourth surface 10D. Second core portion 10E has first surface 10A and a remaining portion of each of third surface 10C and fourth surface 10D. Core 10 is an EI type core, for example.

First core portion 101 has an I shape, and second core portion 10E has an E shape. Second core portion 10E includes: a base portion 14; and a first outer leg 11, a second outer leg 12, and a middle leg 13 that protrude relative to base portion 14 in second direction Z. Top surfaces 11A, 12A, 13A of first outer leg 11, second outer leg 12, and middle leg 13, respectively, are in contact with first core portion 101. Middle leg 13 is disposed between first outer leg 11 and second outer leg 12 in first direction Y. A first space extending through core 10 in third direction X is provided between first outer leg 11 and middle leg 13 in first direction Y and between first core portion 101 and base portion 14 of second core portion 10E in second direction Z. A second space extending through core 10 in third direction X is provided between second outer leg 12 and middle leg 13 in first direction Y and between first core portion 101 and base portion 14 of second core portion 10E in second direction Z. Each of the coil member and printed board 60 is partially disposed in each of the first space and the second space. Specifically, the first space includes: a first portion 20A of coil member 20; and one portion of printed board 60 on which first portion 20A is formed. The second space includes: a second portion 20B; and another portion of printed board 60 on which second portion 20B is formed. Core 10 is not limited to an EI type, but may be an EE type core, a U type core, a UU type core, an EER type core, or an ER type core, for example.

As shown in FIG. 4, core 10 is provided with: a first slit 15 in which a first protruding portion 41 of support portion 30 is accommodated; and a second slit 16 in which a second protruding portion 51 of support portion 30 is accommodated.

First slit 15 is recessed relative to first surface 10A. First slit 15 is provided in second core portion 10E. In a view from second direction Z, first slit 15 is provided in a central portion between first portion 20A and second portion 20B of coil member 20. First slit 15 is provided to penetrate through base portion 14 and reach middle leg 13.

First slit 15 is configured as a through hole penetrating through second core portion 10E, for example. Each first inclined surface 15A is connected to first surface 10A and top surface 13A of middle leg 13. The angle formed between each first inclined surface 15A and top surface 13A is an acute angle.

First slit 15 has a first inclined surface 15A inclined relative to first surface 10A and top surface 13A. First slit 15 has two first inclined surfaces 15A facing each other in first direction Y, for example. One of first inclined surfaces 15A is provided substantially in parallel with the magnetic flux formed around first portion 20A by the current flowing through first portion 20A. The other of first inclined surfaces 15A is provided substantially in parallel with the magnetic flux formed around second portion 20B by the current flowing through second portion 20B. The angle formed between each first inclined surface 15A and first surface 10A is an obtuse angle. Each first inclined surface 15A extends in third direction X. Each first inclined surface 15A has, for example, one portion forming an inner circumferential surface of base portion 14 and a remaining portion forming an inner circumferential surface of middle leg 13. The inner circumferential surface of middle leg 13 is formed, for example, only of an inclined surface inclined relative to top surface 13A. First slit 15 extends in third direction X, for example. The opening width of first slit 15 in first direction Y is shorter than the opening width of first slit 15 in third direction X.

Second slit 16 is recessed relative to second surface 10B. Second slit 16 is provided in first core portion 101. In a view from second direction Z, second slit 16 is provided so as to overlap a part of middle leg 13. In a view from second direction Z, second slit 16 is provided in a central portion between first portion 20A and second portion 20B of coil member 20. In a view from second direction Z, second slit 16 is provided so as to overlap at least a part of first slit 15. Second slit 16 penetrates through first core portion 101, for example. First slit 15 and second slit 16 are provided to be continuous to each other in second direction Z, for example. Second slit 16 extends in third direction X, for example. The opening width of second slit 16 in first direction Y is shorter than the opening width of second slit 16 in third direction X.

Second slit 16 has a second inclined surface 16A inclined relative to second surface 10B. Second slit 16 has two second inclined surfaces 16A facing each other in first direction Y, for example. Each second inclined surface 16A extends in third direction X. Each second inclined surface 16A is connected to second surface 10B. The angle formed between each second inclined surface 16A and second surface 10B is an obtuse angle. Each second inclined surface 16A forms an inner circumferential surface of first core portion 101.

Coil member 20 forms a part of a smoothing coil. Coil member 20 is formed as a wiring pattern on printed board 60. Coil member 20 has a first portion 20A and a second portion 20B that are spaced apart from each other in first direction Y. First portion 20A and second portion 20B extend in third direction X. First portion 20A is provided to penetrate through the first space of core 10. Second portion 20B is provided to penetrate through the second space of core 10. First portion 20A and second portion 20B are provided so as to sandwich middle leg 13 therebetween in first direction Y, and such that the magnetic flux passing through middle leg 13 extends in second direction Z. Coil member 20 has one end connected to rectifier circuit 3, and the other end connected to capacitor 7 and output terminal 111.

The material forming coil member 20 is lower in electric resistivity and higher in thermal conductivity than the material forming printed board 60, and contains an electrically conductive material such as copper (Cu), silver (Ag), gold (Au), tin (Sn), a copper (Cu) alloy, a nickel (Ni) alloy, a gold (Au) alloy, a silver (Ag) alloy, or a tin (Sn) alloy, for example. Coil member 20 has a thickness of 1 μm or more and 5000 or less, and, for example, 100 μm.

Printed board 60 is provided with coil member 20 and first to third through holes. The first to third through holes are spaced apart from each other in first direction Y. The first through hole and the second through hole are provided so as to sandwich first portion 20A therebetween in first direction Y. The second through hole and the third through hole are provided so as to sandwich second portion 20B therebetween in first direction Y. First outer leg 11 is inserted into the first through hole, middle leg 13 is inserted into the second through hole, and second outer leg 12 is inserted into the third through hole. First portion 20A and one portion of printed board 60 on which first portion 20A is formed are provided to penetrate through the first space of core 10. Second portion 20B and another portion of printed board 60 on which second portion 20B is formed are provided to penetrate through the second space of core 10.

Support portion 30 is in contact with at least a part of each of first surface 10A and second surface 10B of core 10 to support core 10. Support portion 30 includes first support portion 40, first protruding portion 41, second support portion 50, and second protruding portion 51.

As described above, first support portion 40 forms a part of a housing of power conversion device 200, for example. First support portion 40 has a fifth surface 40A. Fifth surface 40A is in contact with first surface 10A of core 10. First protruding portion 41 is disposed inside first slit 15. The top portion of first protruding portion 41 is disposed inside middle leg 13. In other words, the top portion of first protruding portion 41 is disposed between first portion 20A and second portion 20B of coil member 20. First slit 15 and first protruding portion 41 are in contact with base portion 14 and middle leg 13 of core 10. First support portion 40 and first protruding portion 41 are integrally molded, for example, by cutting, die casting, forging, molding, or the like.

First protruding portion 41 has a third inclined surface 41A inclined relative to fifth surface 40A. First protruding portion 41 has two third inclined surfaces 41A facing opposite to each other in first direction Y, for example. Third inclined surface 41A of first protruding portion 41 is in contact with the entire first inclined surface 15A of first slit 15. First protruding portion 41 fits into first slit 15, for example.

Preferably, first support portion 40 is provided with a groove portion 43 at a base portion of first protruding portion 41. Groove portion 43 is recessed relative to third inclined surface 41A and fifth surface 40A. Groove portion 43 extends in third direction X. Preferably, the width of groove portion 43 in third direction X is equal to or greater than the width of first protruding portion 41 in third direction X. The shape of the cross section of groove portion 43 perpendicular to third direction X is, for example, a square shape as shown in FIG. 4. The shape of the cross section of groove portion 43 perpendicular to third direction X may be a circular shape or an elliptical shape, for example. The corner portion of second core portion 10E that faces first slit 15 is spaced apart from the surface of groove portion 43. In this case, the corner portion of second core portion 10E is not in contact with first protruding portion 41. When the corner portion of second core portion 10E comes into contact with first protruding portion 41 during construction of coil device 100, the corner portion of second core portion 10E may be chipped. Groove portion 43 can suppress occurrence of such chipping.

Second support portion 50 is fixed to first support portion 40 and provided so as to surround core 10. Second support portion 50 is in contact with second surface 10B, third surface 10C, and fourth surface 10D of core 10. Second support portion 50 has a sixth surface 50A. Sixth surface 50A is in contact with second surface 10B of core 10. Second protruding portion 51 is disposed inside second slit 16. Second support portion 50 and second protruding portion 51 are integrally molded, for example, by cutting, die casting, forging, molding, or the like. The method of connecting first support portion 40 and second support portion 50 is not particularly limited, but first support portion 40 and second support portion 50 are connected, for example, by at least one of fitting and bonding. Specifically, second support portion 50 may be fitted into a slit provided in first support portion 40. Further, second support portion 50 may be fitted into a slit provided in first support portion 40, and may be sandwiched between first support portion 40 and a fixing member disposed on the side opposite to first support portion 40 with respect to second support portion 50. An adhesive may be applied onto this fitting portion.

Second protruding portion 51 has a fourth inclined surface 51A inclined relative to sixth surface 50A. Second protruding portion 51 has two fourth inclined surfaces 51A facing opposite to each other in first direction Y, for example. Fourth inclined surface 51A of second protruding portion 51 is in contact with entire second inclined surface 16A of second slit 16. Second protruding portion 51 fits into second slit 16, for example.

In a view from second direction Z, second protruding portion 51 is provided so as to overlap at least a part of first protruding portion 41. The top portion of first protruding portion 41 and the top portion of second protruding portion 51 face each other in second direction Z, for example. The top portion of first protruding portion 41 and the top portion of second protruding portion 51 are spaced apart from each other in second direction Z, for example.

The shortest distance from first protruding portion 41 to each of first portion 20A and second portion 20B of coil member 20 is shorter, for example, than the shortest distance from first support portion 40 to each of first portion 20A and second portion 20B of coil member 20. The shortest distance from the portion of contact between third inclined surface 41A and first inclined surface 15A to each of first portion 20A and second portion 20B is shorter, for example, than the shortest distance from the portion of contact between first surface 10A and fifth surface 40A to each of first portion 20A and second portion 20B.

The material forming support portion 30 includes, for example, a metal material such as copper (Cu), aluminum (Al), iron (Fe), an iron (Fe) alloy such as SUS304, a copper (Cu) alloy such as phosphor bronze, or an aluminum (Al) alloy such as ADC12. The material forming support portion 30 may be a resin material containing a thermally conductive filler. Such a resin material is, for example, polybutylene terephthalate (PBT), polyphenylene sulfide (PPS), polyether ether ketone (PEEK), or the like. The thermal conductivity of support portion 30 is equal to or higher than the thermal conductivity of core 10, and preferably exceeds the thermal conductivity of core 10. The thermal conductivity of support portion 30 is 0.1 W/(m·K) or more, preferably 1 W/(m·K) or more, and more preferably 10 W/(m·K) or more.

### Functions and Effects

Coil device 100 includes: core 10 having first surface 10A and second surface 10B located opposite to first surface 10A; coil member 20 including first portion 20A and second portion 20B that are spaced apart from each other in first direction Y along first surface 10A; and support portion 30 in contact with first surface 10A and second surface 10B to support core 10. Core 10 includes middle leg 13 sandwiched between first portion 20A and second portion 20B in first direction Y. Core 10 is provided with first slit 15 as the first recessed portion recessed relative to first surface 10A and reaching middle leg 13. Support portion 30 includes first protruding portion 41 disposed inside first slit 15 and in contact with middle leg 13.

When power conversion device 200 is driven and coil device 100 is driven, core 10 and coil member 20 generate heat due to energy loss. In particular, since middle leg 13 is sandwiched between first portion 20A and second portion 20B of coil member 20, middle leg 13 is more likely to generate heat due to energy loss in core 10 as compared with first outer leg 11 and second outer leg 12. In addition, since middle leg 13 is interposed in coil member 20 as a heat generating element, heat is less likely to be dissipated from middle leg 13 as compared with first outer leg 11 and second outer leg 12.

In contrast, coil device 100 includes: a first path extending from middle leg 13 through base portion 14 of second core portion 10E to first support portion 40; and a second path extending from middle leg 13 through first protruding portion 41 to first support portion 40, each of these paths serving as a heat dissipation path for heat generated in middle leg 13. Thus, in coil device 100, core 10 is enhanced in heat dissipation performance as compared with a conventional coil device not provided with the above-mentioned second path. Accordingly, a temperature rise in core 10 is suppressed during the operation of coil device 100.

Further, second support portion 50 of support portion 30 is in contact with second surface 10B. In other words, coil device 100 further includes a third path extending from middle leg 13 through first core portion 101 to second support portion 50 as the above-mentioned heat dissipation path for the heat generated in middle leg 13. Thus, in coil device 100, a temperature rise in core 10 is more effectively suppressed during the operation of coil device 100. Further, the temperature difference between first surface 10A and second surface 10B of core 10 in coil device 100 is smaller than that in coil device 100 not provided with the third path as the above-mentioned heat dissipation path. In addition, part of the heat transferred to second support portion 50 is radiated from second support portion 50 to the outside of coil device 100, and the remainder of the heat transferred to second support portion 50 is transferred from second support portion 50 to first support portion 40.

In coil device 100, first slit 15 has first inclined surface 15A inclined relative to first surface 10A. First protruding portion 41 has third inclined surface 41A configured as the first contact surface in contact with first inclined surface 15A.

Middle leg 13 of coil device 100 is provided with second slit 16 as a second recessed portion recessed relative to second surface 10B. In a view from second direction Z, second slit 16 overlaps at least a part of first slit 15. Support portion 30 further includes second protruding portion 51 in contact with at least a part of second slit 16.

Coil device 100 as described above further includes a fourth path extending from middle leg 13 through first core portion 101 and second protruding portion 51 to second support portion 50 as the above-mentioned heat dissipation path for the heat generated in middle leg 13. Thus, in coil device 100, core 10 is enhanced in heat dissipation performance as compared with coil device 100 not provided with the fourth path. Thereby, a temperature rise in core 10 is more effectively suppressed during the operation of coil device 100.

In coil device 100 as described above, second slit 16 has second inclined surface 16A inclined relative to second surface 10B. Second protruding portion 51 has fourth inclined surface 51A configured as the second contact surface in contact with second inclined surface 16A.

In the above-mentioned coil device 100, generation of eddy currents on second inclined surface 16A and fourth inclined surface 51A is suppressed as in first inclined surface 15A and third inclined surface 41A. Thus, core 10 is enhanced in heat dissipation performance while still suppressing heat generation on the surfaces of first slit 15 and first protruding portion 41 during the operation of coil device 100.

In the above-mentioned coil device 100, groove portion 43 may be filled with a sealing member. Preferably, the thermal conductivity of the material forming the sealing member is higher than the thermal conductivity of air.

### Second Embodiment

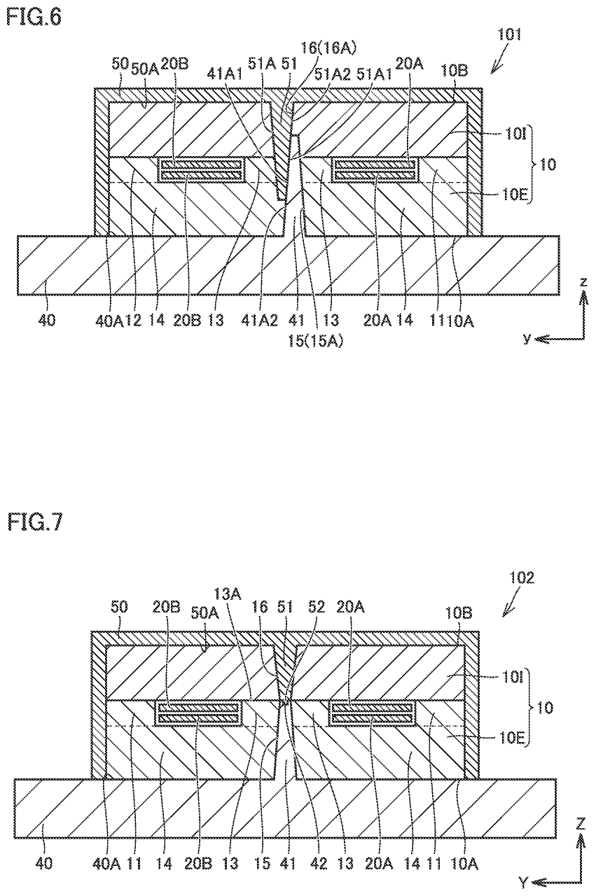

FIG. 6 is a cross-sectional view of coil device 101 according to the second embodiment. Coil device 101 according to the second embodiment has basically the same configuration as that of coil device 100 according to the first embodiment, but is different from coil device 100 in that second protruding portion 51 is in contact with middle leg 13. FIG. 6 does not show printed board 60.

As shown in FIG. 6, first slit 15 and second slit 16 are provided, for example, to be continuous to each other and configured as a through hole extending from first surface 10A to second surface 10B. Second slit 16 is provided in first core portion 101 and second core portion 10E. Second slit 16 is provided to penetrate through first core portion 101 and reach middle leg 13 of second core portion 10E. In other words, one portion of second inclined surface 16A is formed in first core portion 101 while a remaining portion of second inclined surface 16A is formed in second core portion 10E.

First slit 15 is provided, for example, in first core portion 101 and second core portion 10E. First slit 15 is provided to penetrate through second core portion 10E and reach first core portion 101. In other words, one portion of first inclined surface 15A is formed in second core portion 10E while a remaining portion of first inclined surface 15A is formed in first core portion 101.

From a different point of view, first core portion 101 is provided with a through hole defining a bottom portion of first slit 15 and a side portion of second slit 16. Second core portion 10E is provided with a through hole defining a side portion of first slit 15 and a bottom portion of second slit 16. In each slit, the side portion is located closer to the opening end than the bottom portion.

Second protruding portion 51 is disposed inside second slit 16 and in contact with first core portion 101 and middle leg 13. First protruding portion 41 is disposed inside first slit 15 and in contact with middle leg 13 and second core portion 10E.

First protruding portion 41 is in contact with second protruding portion 51, for example. The surface of contact between first protruding portion 41 and second protruding portion 51 is inclined relative to fifth surface 40A and sixth surface 50A. First protruding portion 41 and second protruding portion 51 have two-fold rotational symmetry, for example. First core portion 101, second core portion 10E, first protruding portion 41, and second protruding portion 51 are fitted to one another.

First protruding portion 41 and second protruding portion 51 are arranged side by side in first direction Y. One portion 41A1 of one third inclined surface 41A of the above-mentioned two third inclined surfaces 41A of first protruding portion 41 that faces second portion 20B is in contact with one portion 51A1 of one fourth inclined surface 51A of the above-mentioned two fourth inclined surfaces 51A of second protruding portion 51 that faces first portion 20A. A remaining portion 41A2 of the above-mentioned one third inclined surface 41A is in contact with base portion 14 of second core portion 10E. A remaining portion 51A2 of the above-mentioned one fourth inclined surface 51A is in contact with first core portion 101.

The other third inclined surface 41A of the above-mentioned two third inclined surfaces 41A that faces first portion 20A is in contact with, for example, first core portion 101 and middle leg 13 and base portion 14 of second core portion 10E. The other fourth inclined surface 51A of the above-mentioned two fourth inclined surfaces 51A that faces second portion 20B is in contact with, for example, first core portion 101 and middle leg 13 and base portion 14 of second core portion 10E.

Since coil device 101 has the same configuration as that of coil device 100, the same effect as that of coil device 100 can be achieved.

Further, in coil device 101, first protruding portion 41 and second protruding portion 51 are in contact with middle leg 13. Thus, coil device 101 further includes a fifth path extending from middle leg 13 only through second protruding portion 51 to second support portion 50 as the above-mentioned heat dissipation path for the heat generated in middle leg 13. In the above-mentioned fifth path, middle leg 13 and second support portion 50 are connected without having first core portion 101 interposed therebetween. As a result, in coil device 101, core 10 is enhanced in heat dissipation performance as compared with coil device 100 not provided with the fifth path. Thereby, a temperature rise in core 10 is more effectively suppressed during the operation of coil device 101.

Further, in coil device 101, first protruding portion 41 and second protruding portion 51 are in contact with each other. Thus, in coil device 101, heat is more efficiently conducted between first protruding portion 41 and second protruding portion 51 as compared with coil device 100 in which first protruding portion 41 and second protruding portion 51 are not in contact with each other. Accordingly, a temperature rise in core 10 is more effectively suppressed during the operation of coil device 101.

In coil device 101, a part of third inclined surface 41A of first protruding portion 41 is configured as a third contact surface that is in contact with second protruding portion 51. In other words, first protruding portion 41 has a third contact surface inclined relative to first surface 10A and in contact with second protruding portion 51. Thus, also in coil device 101, generation of eddy currents on first inclined surface 15A, second inclined surface 16A, third inclined surface 41A, and fourth inclined surface 51A is suppressed as in coil device 100. In coil device 101, core 10 is enhanced in heat dissipation performance while still suppressing heat generation on each of the surfaces of first slit 15 and first protruding portion 41.

In coil device 101, second protruding portion 51 may have any configuration as long as second protruding portion 51 is in contact with middle leg 13, and, for example, second protruding portion 51 may not be in contact with first protruding portion 41.

### Third Embodiment

FIG. 7 is a cross-sectional view of a coil device 102 according to the third embodiment. Coil device 102 according to the third embodiment has basically the same configuration as that of coil device 100 according to the first embodiment, but is different from coil device 100 in that first protruding portion 41 is fitted to second protruding portion 51. FIG. 7 does not show printed board 60.

As shown in FIG. 7, first slit 15 penetrates through second core portion 10E. Second slit 16 penetrates through first core portion 101. First slit 15 and second slit 16 are provided to be continuous to each other and configured as a through hole extending from first surface 10A to second surface 10B.

First protruding portion 41 is fitted to second protruding portion 51. The top portion of first protruding portion 41 is provided with a groove portion 42 recessed relative to the top surface of first protruding portion 41. The top portion of second protruding portion 51 is provided with a protrusion 52 protruding relative to the top surface of second protruding portion 51. Protrusion 52 fits into groove portion 42. The top surface of first protruding portion 41 is in contact with the top surface of second protruding portion 51, for example. The top surface of first protruding portion 41 and the top surface of second protruding portion 51 are provided to be continuous to top surface 13A of middle leg 13, for example.

Since coil device 102 has the same configuration as that of coil device 100, the same effect as that of coil device 100 can be achieved.

Further, in coil device 102, first protruding portion 41 is fitted to second protruding portion 51. Thus, in coil device 102, heat is more efficiently conducted between first protruding portion 41 and second protruding portion 51 than in coil device 100 in which first protruding portion 41 and second protruding portion 51 are not in contact with each other. Thereby, a temperature rise in core 10 is more effectively suppressed during the operation of coil device 101. Further, also when coil device 102 vibrates, the state shown in FIG. 7 is readily maintained. The state shown in FIG. 7 specifically means the state in which first protruding portion 41 and second protruding portion 51 are in contact with each other, and first support portion 40 and second support portion 50 provide support with core 10 interposed therebetween. Thus, in coil device 102, abnormalities such as cracking of core 10 during vibration is less likely to occur as compared with coil device 100.

In coil device 102, the top portion of first protruding portion 41 may be provided with a protrusion that protrudes relative to the top surface of first protruding portion 41, and the top portion of second protruding portion 51 may be provided with a groove portion that is recessed relative to the top surface of second protruding portion 51.

In coil device 102, the top surface of first protruding portion 41 may be disposed inside middle leg 13. The top surface of second protruding portion 51 may be disposed inside first core portion 101.

### Fourth Embodiment

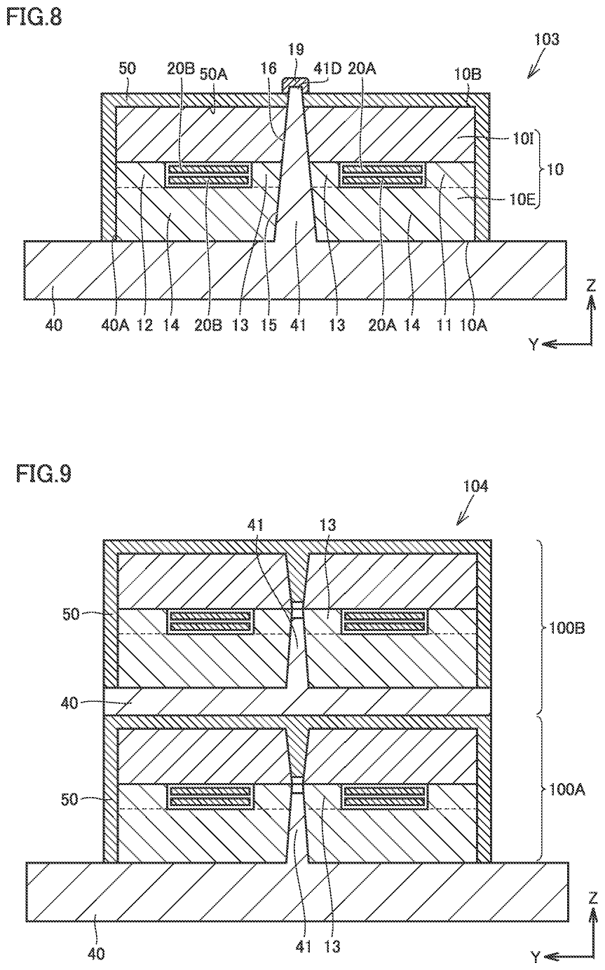

FIG. 8 is a cross-sectional view of a coil device 103 according to the fourth embodiment. Coil device 102 according to the fourth embodiment has basically the same configuration as that of coil device 100 according to the first embodiment, but is different from coil device 100 in that first protruding portion 41 connects first support portion 40 and second support portion 50. FIG. 8 does not show printed board 60.

As shown in FIG. 8, first slit 15 penetrates through second core portion 10E. Second slit 16 penetrates through first core portion 101. First slit 15 and second slit 16 are configured as a through hole extending from first surface 10A to second surface 10B. The top portion of first protruding portion 41 is connected to second support portion 50.

Second support portion 50 is provided with a through hole, for example. The through hole is provided in a region overlapping middle leg 13 in a view from second direction Z. First protruding portion 41 extends through the through hole, for example. First protruding portion 41 has, for example, a protrusion 41D protruding relative to second support portion 50 toward the opposite side of core 10. A fastening member 19 is fastened to protrusion 41D. Fastening member 19 is provided with a screw hole, for example, by tapping processing. Protrusion 41D is provided with a thread formed, for example, by die processing. In the state where fastening member 19 is fastened to protrusion 41D, fastening member 19 is in contact with second support portion 50, for example.

First protruding portion 41 is in contact, for example, with first core portion 101 and second core portion 10E. For example, third inclined surface 41A of first protruding portion 41 is entirely in contact with first inclined surface 15A of first slit 15 and second inclined surface 16A of second slit 16. First inclined surface 15A of first slit 15 and second inclined surface 16A of second slit 16 form one plane, for example.

In addition to the first path to the third path, coil device 103 further includes a sixth path extending from middle leg 13 to second support portion 50 without passing through first core portion 101 and second protruding portion 51, as the above-mentioned heat dissipation path for the heat generated in middle leg 13. The portion of connection between first protruding portion 41 and second support portion 50 in the sixth path is more distant from middle leg 13 than the portion of connection between first protruding portion 41 and second protruding portion 51 in the fourth path and the fifth path. Thus, the performance of heat dissipation to middle leg 13 is higher in coil device 103 than in coil devices 100 to 102 in which the fourth path and the fifth path are formed in place of the sixth path.

### Fifth Embodiment

FIG. 9 is a cross-sectional view of a coil device 104 according to the fifth embodiment. Coil device 104 according to the fifth embodiment has basically the same configuration as that of coil device 100 according to the first embodiment, but is different from coil device 100 in that coil device 104 includes a plurality of coil devices 100A and 100B stacked in second direction Z. FIG. 9 does not show printed board 60. From a different point of view, coil device 104 is configured as a stack of a plurality of coil devices 100A and 100B.

As shown in FIG. 9, coil devices 100A and 100B each basically have the same configuration as that of coil device 100. Second support portion 50 of coil device 100A disposed on the lower side is connected to first support portion 40 of coil device 100B disposed on the upper side. In a view from second direction Z, first support portion 40 of coil device 100B disposed on the upper side is identical in shape and size, for example, to second support portion 50 of coil device 100A. First support portion 40 of coil device 100B is in contact with second support portion 50 of coil device 100A, for example, with no gap interposed therebetween.

First support portion 40 of coil device 100A forms a part of a housing of power conversion device 200, for example. Second support portion 50 of coil device 100B is in contact with another part of the housing of power conversion device 200, for example.

Coil device 104 may include two or more types of coil devices among coil devices 100 to 103. Coil device 104 may include coil device 100, coil device 101, and coil device 102, for example. Coil device 104 may include coil device 103. In this case, first support portion 40 of each of coil devices 100 to 103 disposed above coil device 103 is provided to be in contact, for example, with second support portion 50 and fastening member 19 of coil device 103.

In coil device 104, middle legs 13 of coil devices 100A and 100B are connected to a plurality of first support portions 40 and a plurality of second support portions 50 with the respective first protruding portions 41 interposed therebetween. Thus, also in coil device 104, the heat dissipation performance of core 10 in each of coil devices 100A and 100B is higher than that of the coil device formed by stacking the above-mentioned conventional coil devices. Thus, a temperature rise in each core 10 is suppressed during the operation of coil device 104.

Coil device 104 is suitable, for example, for power conversion device 200 configured as a DC/DC conversion device for high power transmission. The footprint of coil device 104 in such power conversion device 200 is smaller than the total sum of the footprints of a plurality of coil devices 100 to 103 that are arranged side by side in first direction Y and third direction X.

### Sixth Embodiment

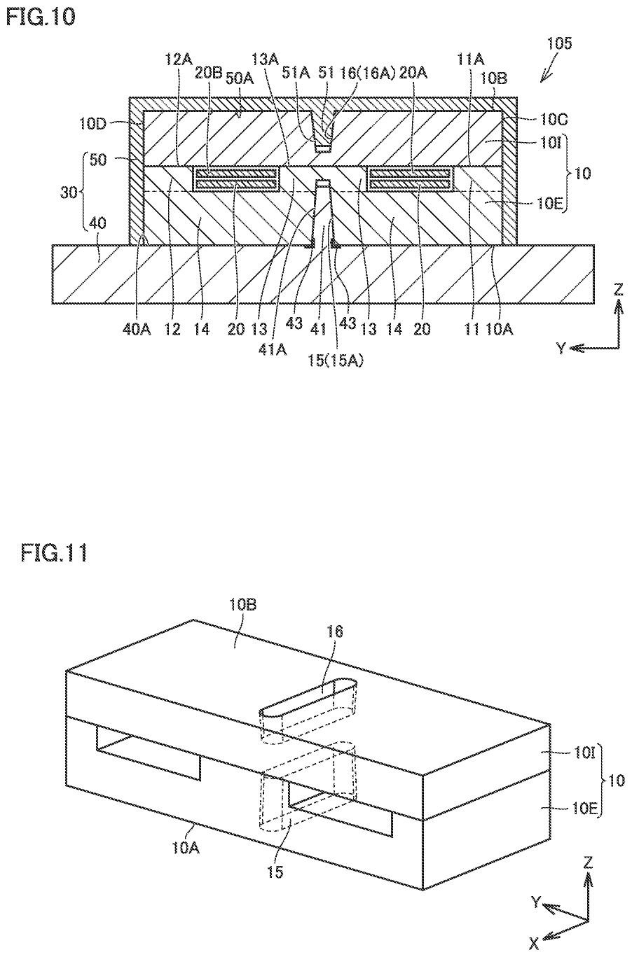

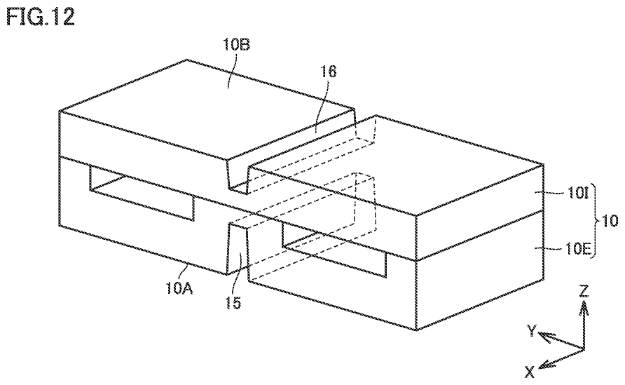

FIG. 10 is a cross-sectional view of a coil device 105 according to a sixth embodiment. FIG. 11 is a perspective view showing core 10 shown in FIG. 10. Coil device 105 according to the sixth embodiment has basically the same configuration as that of coil device 100 according to the first embodiment, but is different from coil device 100 in that first slit 15 and second slit 16 are not configured as a through hole extending from first surface 10A to second surface 10B.

First slit 15 is configured as a recessed portion that does not penetrate through second core portion 10E, for example. First slit 15 is recessed relative to first surface 10A. First slit 15 is provided in second core portion 10E. First slit 15 is provided so as to penetrate through base portion 14 and reach middle leg 13. First inclined surface 15A of first slit 15 is in surface contact with third inclined surface 41A of first protruding portion 41.

Second slit 16 is configured as a recessed portion that does not penetrate through first core portion 101, for example. Second slit 16 is recessed relative to second surface 10B. Second slit 16 is provided in first core portion 101. Second inclined surface 16A of second slit 16 is in surface contact with fourth inclined surface 51A of second protruding portion 51.

As shown in FIG. 11, both end portions of first slit 15 in the X direction are located, for example, inside in the X direction with respect to both end portions of second core portion 10E in the X direction. Both end portions of second slit 16 in the X direction are located, for example, inside in the X direction with respect to both end portions of first core portion 101 in the X direction.

In a view from the Z direction, the planar shape of each end portion of first slit 15 in the X direction is not particularly limited but may be a semicircular shape, for example. In a view from the Z direction, the planar shape of each end portion of first protruding portion 41 in the X direction is not particularly limited as long as first slit 15 and first protruding portion 41 do not interfere with each other, but may be a semicircular shape, for example. In a cross section perpendicular to the Y direction, the angle formed by each end face of first slit 15 in the X direction and first surface 10A is an obtuse angle. In a cross section perpendicular to the Y direction, the distance between both end faces of first slit 15 in the X direction gradually decreases, for example, with distance from first surface 10A in the Z direction. Both end faces of first slit 15 in the X direction are in surface contact, for example, with both end faces of first protruding portion 41 in the X direction.

In a view from the Z direction, the planar shape of each end portion of second slit 16 in the X direction is not particularly limited, but may be a semicircular shape, for example. In a view from the Z direction, the planar shape of each end portion of second protruding portion 51 in the X direction is not particularly limited as long as second slit 16 and second protruding portion 51 do not interfere with each other, but may be a semicircular shape, for example. In a cross section perpendicular to the Y direction, an angle formed by each end face of second slit 16 in the X direction and second surface 10B is an obtuse angle. In a cross section perpendicular to the Y direction, the distance between both end faces of second slit 16 in the X direction gradually decreases, for example, with distance from second surface 10B in the Z direction. Both end faces of second slit 16 in the X direction are in surface contact, for example, with both end faces of second protruding portion 51 in the X direction.

In coil device 105, in the same manner as in coil device 100, first inclined surface 15A of first slit 15 is in surface contact with third inclined surface 41A of first protruding portion 41, and also, second inclined surface 16A of second slit 16 is in surface contact with fourth inclined surface 51A of second protruding portion 51. Thus, first slit 15 receives force applied in a direction to push first inclined surfaces 15A apart from each other. Second slit 16 receives force applied in a direction to push second inclined surfaces 16A apart from each other.

In coil device 100, first slit 15 and second slit 16 are configured as a through hole, and thus, the above-mentioned force may damage first core portion 101 and second core portion 10E. On the other hand, first slit 15 and second slit 16 of coil device 105 are not configured as a through hole. Thus, first slit 15 and second slit 16 of coil device 105 are higher in strength than first slit 15 and second slit 16 of coil device 100. As a result, in coil device 105, the above-mentioned force is less likely to damage first core portion 101 and second core portion 10E, as compared with coil device 100.

As shown in FIG. 12, first slit 15 of coil device 105 may be formed so as to extend through second core portion 10E from one side surface to the other side surface in the X direction. Second slit 16 of coil device 105 may be formed so as to extend through first core portion 101 from one side surface to the other side surface in the X direction.

In coil device 105, only first slit 15 may be configured as a recessed portion or a groove portion, and second slit 16 may be configured as a through hole. Alternatively, only second slit 16 may be configured as a recessed portion or a groove portion, and first slit 15 may be configured as a through hole.

### Modification

In each of coil devices 100 to 105, first support portion 40 may be in contact with at least a part of first surface 10A of core 10. Third inclined surface 41A of first protruding portion 41 may be in contact with at least a part of first inclined surface 15A of first slit 15. In each of coil devices 100 to 102 and 104, second support portion 50 may be in contact with at least a part of each of second surface 10B, third surface 10C, and fourth surface 10D of core 10. Fourth inclined surface 51A of second protruding portion 51 may be in contact with at least a part of second inclined surface 16A of second slit 16.

In each of coil devices 100 to 105, first inclined surface 15A may be orthogonal to first surface 10A. Third inclined surface 41A may be orthogonal to fifth surface 40A. Second inclined surface 16A may be orthogonal to second surface 10B. Fourth inclined surface 51A may be orthogonal to sixth surface 50A.

Coil devices 100 to 105 each may include a plurality of first slits 15 and a plurality of first protruding portions 41. Coil devices 100 to 102, 104, and 105 each may include a plurality of second slits 16 and a plurality of second protruding portions 51. The plurality of first slits 15 are spaced apart from each other, for example, in at least one of first direction Y and third direction X. The plurality of first protruding portions 41 are spaced apart from each other, for example, in at least one of first direction Y and third direction X. The plurality of second slits 16 are spaced apart from each other, for example, in at least one of first direction Y and third direction X. The plurality of second protruding portions 51 are spaced apart from each other, for example, in at least one of first direction Y and third direction X.

In each of coil devices 100 to 102 and 105, the positions of the I-type core and the E-type core in core 10 may be interchanged with each other. First core portion 101 may be disposed on the second support portion 50 side while second core portion 10E may be disposed on the first support portion 40 side.

In each of coil devices 100 to 105, coil member 20 does not have to be configured as a wiring pattern formed on printed board 60 but may be configured as a winding.

Although each of coil devices 100 to 105 is configured as a smoothing coil in power conversion device 200, the present invention is not limited thereto. Each of coil devices 100 to 104 may be configured as at least one of transformer 121, resonance coil 122, and filter coil 123 in power conversion device 200.

First support portion 40 of coil device 100 does not have to be provided with groove portion 43. First support portion 40 of each of coil devices 101 to 104 may be provided with groove portion 43 as in coil device 100 shown in FIG. 4. In this case, groove portion 43 may be filled with the above-mentioned sealing member.

Although the embodiments of the present invention have been described as above, the above-described embodiments may be variously modified. Further, the scope of the present invention is not limited to the above-described embodiments. The scope of the present invention is defined by the terms of the claims and is intended to include any modifications within the meaning and scope equivalent to the terms of the claims.

### REFERENCE SIGNS LIST

1 inverter circuit, 2 transformer circuit, 3 rectifier circuit, 4 smoothing circuit, 5 control circuit, 6E, 6F, 6G, 6H diode, 6A, 6B, 6C, 6D switching element, 7, 8 capacitor, 10 core, 10A first surface, 10B second surface, 10C third surface, 10D fourth surface, 10E second core portion, 101 first core portion, 11 first outer leg, 11A, 12A, 13A top surface, 12 second outer leg, 13 middle leg, 14 base portion, 15 first slit, 15A first inclined surface, 16 second slit, 16A second inclined surface, 19 fastening member, 20 coil member, 20A first portion, 20B second portion, 30 support portion, 40 first support portion, 40A fifth surface, 41 first protruding portion, 41A1, 51A1 one portion, 41A2, 51A2 remaining portion, 41A third inclined surface, 41D, 52 protrusion, 42 groove portion, 50 second support portion, 50A sixth surface, 51 second protruding portion, 51A fourth inclined surface, 60 printed board, 100, 100A, 100B, 101, 102, 103, 104 coil device, 110 input terminal, 111 output terminal, 200 power conversion device.

1. A coil device comprising:
a core having a first surface and a second surface located opposite to the first surface;
a coil including a first portion and a second portion that are spaced apart from each other in a first direction along the first surface; and
a support portion in contact with at least a part of each of the first surface and the second surface to support the core, wherein
in a view from a second direction intersecting the first direction, the core includes a middle leg sandwiched between the first portion and the second portion in the first direction, the core is provided with a first recessed portion recessed relative to the first surface and reaching the middle leg,-and
the support portion includes a first protruding portion disposed inside the first recessed portion and in contact with the middle leg, the core is provided with a second recessed portion recessed relative to the second surface,
in a view from the second direction, the second recessed portion overlaps at least a part of the middle leg, and
the support portion further includes a second protruding portion in contact with at least a part of the second recessed portion.

2. The coil device according to claim 1, wherein
the first recessed portion has a first inclined surface inclined relative to the first surface, and
the first protruding portion has a first contact surface in contact with the first inclined surface.

3. (canceled)

4. The coil device according to claim 1, wherein
the second recessed portion has a second inclined surface inclined relative to the second surface, and
the second protruding portion has a second contact surface in contact with the second inclined surface.

5. The coil device according to claim 1, wherein
the second recessed portion is provided to reach the middle leg, and
the second protruding portion is in contact with the middle leg.

6. The coil device according to claim 1, wherein the first recessed portion and the second recessed portion are provided to be continuous to each other and configured as a through hole extending from the first surface to the second surface.

7. The coil device according to claim 6, wherein the first protruding portion has a third contact surface in contact with the second protruding portion inside the through hole.

8. The coil device according to claim 7, wherein the third contact surface is inclined relative to the first surface.

9. The coil device according to claim 7, wherein the first protruding portion is fitted to the second protruding portion.

10. A coil device comprising:
a core having a first surface and a second surface located opposite to the first surface;
a coil including a first portion and a second portion that are spaced apart from each other in a first direction along the first surface; and
a support portion in contact with at least a part of each of the first surface and the second surface to support the core, wherein
in a view from a second direction intersecting the first direction, the core includes a middle leg sandwiched between the first portion and the second portion in the first direction,
the core is provided with a first recessed portion recessed relative to the first surface and reaching the middle leg, and
the support portion includes a first protruding portion disposed inside the first recessed portion and in contact with the middle leg,
the first recessed portion is configured as a through hole extending from the first surface to the second surface,
the support portion further includes a first support portion in contact with the first surface and a second support portion in contact with the second surface, and
the first protruding portion connects the first support portion and the second support portion,
the first protruding portion has a portion inserted into a hole provided in the second support portion, and
the portion of the first protruding portion is connected to the second support portion.

11. The coil device according to claim 1, further comprising:
a first coil device; and
a second coil device stacked on the first coil device in the first direction, wherein
the first coil device and the second coil device each are configured as the coil device according to claim 1, and
the support portion of the first coil device is in contact with the support portion of the second coil device.

12. A power conversion device comprising:
a main conversion circuit to convert received electric power and output converted electric power; and
a control circuit to output a control signal for controlling the main conversion circuit to the main conversion circuit, wherein
the main conversion circuit includes the coil device according to claim 1.

13. The coil device according to claim 10, wherein
the first protruding portion has a protrusion penetrating the hole provided in the second support portion and protruding relative to the second support portion toward the opposite side of the core.

14. The coil device according to claim 13, further comprising:
a fastening member fastened to the protrusion.

15. The coil device according to claim 4, wherein
the second recessed portion is provided to reach the middle leg, and
the second protruding portion is in contact with the middle leg.

16. The coil device according to claim 2, wherein the first recessed portion and the second recessed portion are provided to be continuous to each other and configured as a through hole extending from the first surface to the second surface.

17. The coil device according to claim 4, wherein the first recessed portion and the second recessed portion are provided to be continuous to each other and configured as a through hole extending from the first surface to the second surface.

18. The coil device according to claim 5, wherein the first recessed portion and the second recessed portion are provided to be continuous to each other and configured as a through hole extending from the first surface to the second surface.

19. The coil device according to claim 8, wherein the first protruding portion is fitted to the second protruding portion.
